(19) United States
(12) Patent Application Publication
(10) Pub. No.: US 2026/0360715 A1
(43) Pub. Date: Nov. 12, 2026

(54) LITHIUM SECONDARY BATTERY

(71) Applicant: SK ON CO., LTD., Seoul (KR)

(72) Inventors: Young Uk PARK, Daejeon (KR); In Haeng CHO, Daejeon (KR); Seung Hyun KIM, Daejeon (KR); Min Woo PARK, Daejeon (KR); Yu Na SHIM, Daejeon (KR); Min Young LEE, Daejeon (KR); Yong Hyun CHO, Daejeon (KR)

(21) Appl. No.: 19/124,888

(22) PCT Filed: Oct. 23, 2023
(86) PCT No.: PCT/KR2023/016458

§ 371 Date: Apr. 28, 2025

(30) Foreign Application Priority Data
Nov. 1, 2022 (KR) 10-2022-0143750

(51) Int. Cl. H01M 4/505; H01M 10/0525; H01M 10/0569

(52) U.S. Cl. CPC H01M 4/505; H01M 10/0525; H01M 10/0569; H01M 2300/0037

(57) ABSTRACT

A lithium secondary battery according to the embodiments of the present disclosure includes a cathode which includes a cathode active material including lithium metal oxide particles having a ratio of the number of moles of lithium to the total number of moles of metal excluding lithium of 1.05 or more, an anode disposed to face the cathode, and a non-aqueous electrolyte including a non-aqueous organic solvent and a lithium salt, wherein the content of a cyclic carbonate compound included in the non-aqueous electrolyte is less than 2 wt % based on the total weight of the non-aqueous electrolyte.

### CROSS-REFERENCE TO RELATED APPLICATION

This patent application is a national stage application of PCT/KR2023/016458 filed on Oct. 23, 2023, which claims the priority and benefits of Korean patent application No. 10-2022-0143750, filed on Nov. 1, 2022, the disclosure of which is incorporated herein by reference in its entirety.

### TECHNICAL FIELD

The disclosure of the present application is related to a lithium secondary battery.

### BACKGROUND ART

A secondary battery is a battery that can be repeatedly charged and discharged. With rapid progress of information and communication technology and display industries, the secondary battery has been widely applied to various portable electronic telecommunication devices such as a camcorder, a mobile phone, a laptop computer, etc. as their power sources. Recently, a battery pack including the secondary battery has also been developed and applied to eco-friendly automobiles such as an electric vehicle, a hybrid vehicle, etc., as their power sources.

Examples of the secondary battery may include a lithium secondary battery, a nickel-cadmium battery, a nickel-hydrogen battery and the like. Among them, the lithium secondary battery has a high operating voltage and a high energy density per unit weight, making it advantageous in terms of charging speed and lightweight design, such that development thereof is progressing in this regard.

A cathode active material of the lithium secondary battery may include an over-lithiated cathode active material having a molar ratio of lithium of 1.1 or more. The over-lithiated cathode active material may exhibit high capacity characteristics, but its cycle life characteristics may deteriorate due to the requirement for high voltage operation.

### SUMMARY OF INVENTION

### Problems to be Solved by Invention

According to an aspect of the present disclosure, a lithium secondary battery with improved capacity characteristics and driving stability may be provided.

### Means for Solving Problems

A lithium secondary battery according to exemplary embodiments includes: a cathode which comprises a cathode active material including lithium metal oxide particles; an anode disposed to face the cathode; and a non-aqueous electrolyte comprising a non-aqueous organic solvent and a lithium salt, wherein a ratio of the number of moles of lithium included in the lithium metal oxide particles to the total number of moles of metals excluding lithium included in the lithium metal oxide particles is 1.05 or more, and a content of a cyclic carbonate compound included in the non-aqueous electrolyte is less than 2 wt % based on a total weight of the non-aqueous electrolyte.

In some embodiments, the cyclic carbonate compound may include at least one selected from the group consisting of ethylene carbonate, propylene carbonate, gamma-butyrolactone and fluoroethylene carbonate.

In some embodiments, the non-aqueous electrolyte may not include the cyclic carbonate compound.

In some embodiments, the non-aqueous organic solvent may include a linear carbonate compound and a propionate compound.

In some embodiments, a content of the propionate compound may be 5% by volume to 60% by volume based on a total volume of the non-aqueous organic solvent.

In some embodiments, the content of the propionate compound may be 5% by volume to 15% by volume based on the total volume of the non-aqueous organic solvent.

In some embodiments, the propionate compound may include at least one selected from the group consisting of methyl propionate, ethyl propionate and propyl propionate.

In some embodiments, the linear carbonate compound may include at least one selected from the group consisting of dimethyl carbonate, diethyl carbonate, dipropyl carbonate, ethylmethyl carbonate, methylpropyl carbonate and ethylpropyl carbonate.

In some embodiments, the lithium salt may include at least one selected from the group consisting of lithium tetrafluoroborate (LiBF₄), lithium hexafluorophosphate (LiPF₆) and lithium difluorophosphate (LiPO₂F₂).

In some embodiments, the lithium metal oxide particles may be represented by Formula 1 below:

Liₐ[MₓNi_{y}Mn_{z}]O_{b} [Formula 1]

In Formula 1, Mis at least one of Co, Na, Ca, Y, Hf, Ta, Fe, B, Si, Ba, Ra, Mg, V, Ti, Al, Ru, Zr, W, Sn, Nb, Mo, Cu, Zn, Cr, Ga, V, and Bi, and x, y, z, a and by satisfy 0≤x≤0.9, 0≤y≤0.9, x+y>0, 0.1≤z≤0.9, 1.8≤a+x+y+z≤2.2, 1.05≤a/(x+y+z)≤1.95, and 1.8≤b≤2.2.

### Advantageous Effects

The cathode according to the embodiments of the present disclosure includes a cathode active material including lithium metal oxide particles containing excess lithium. In this case, lithium may exist in the transition metal layer of the layered structure of the lithium metal oxide particles. Accordingly, the capacity characteristics of the cathode active material may be improved.

According to exemplary embodiments, the lithium secondary battery includes a non-aqueous electrolyte. The content of a cyclic carbonate compound included in the non-aqueous electrolyte is less than 2% by weight (“wt %”). Within the above range, the content of the cyclic carbonate compound, which is easily decomposed in a high voltage environment, is reduced, thereby improving the cycle life characteristics during high-voltage charge and discharge.

The lithium secondary battery of the present disclosure may be widely applied in green technology fields, such as electric vehicles, battery charging stations, as well as solar power generation, wind power generation, and the like, which use the batteries. The lithium secondary battery of the present disclosure may be used in eco-friendly electric vehicles, hybrid vehicles, and the like, which are aimed at mitigating climate change by reducing air pollution and greenhouse gas emission.

### BRIEF DESCRIPTION OF DRAWINGS

FIGS. 1 and 2 are a schematic plan view and a cross-sectional view illustrating a rechargeable lithium battery according to exemplary embodiments, respectively.

### MODE FOR CARRYING OUT INVENTION

Embodiments of the present disclosure provide a lithium secondary battery including a cathode, an anode and an electrolyte.

Hereinafter, the embodiments of the present disclosure will be described in detail. However, these embodiments are merely examples, and the present disclosure is not limited to the specific embodiments described as the example.

In the exemplary embodiments, the lithium secondary battery includes a cathode, an anode disposed to face the cathode, and a non-aqueous electrolyte.

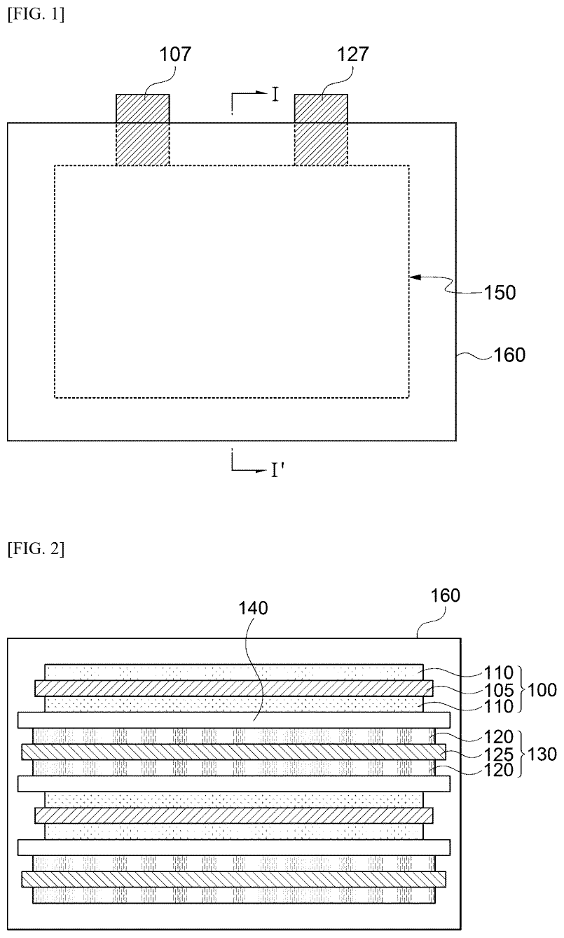

The detailed structure of the lithium secondary battery will be described below with reference to FIGS. 1 and 2.

In exemplary embodiments, the cathode includes a cathode active material including lithium metal oxide particles containing excess lithium. For example, lithium may exist in a transition metal layer of a layered structure of lithium metal oxide particles. Accordingly, the capacity characteristics of the cathode active material may be improved to be similar to the theoretical capacity (250 mAh/g) of the layered structure.

In exemplary embodiments, a ratio of the number of moles of lithium included in the lithium metal oxide particles to the total number of moles of metal excluding lithium included in the lithium metal oxide particles may be 1.05 or more, and in some embodiments, 1.2 or more. Within the above range, lithium may sufficiently exist in the transition metal layer in addition to the lithium layer of the layered structure of the lithium metal oxide particles.

In one embodiment, the lithium metal oxide particles may be represented by Formula 1 below.

Liₐ[MₓNi_{y}Mn_{z}]O_{b} [Formula 1]

In Formula 1, Mis at least one of Co, Na, Ca, Y, Hf, Ta, Fe, B, Si, Ba, Ra, Mg, V, Ti, Al, Ru, Zr, W, Sn, Nb, Mo, Cu, Zn, Cr, Ga, V and Bi, and x, y, z, a and b may satisfy 0≤x≤0.9, 0≤y≤0.9, x+y>0, 0.1≤z≤0.9, 1.8≤a+x+y+z≤2.2, 1.05≤a/(x+y+z)≤1.95, and 1.8≤b≤2.2.

According to some embodiments, in Formula 1, a, x, y and z may satisfy 1.2≤a/(x+y+z)≤1.8. According to some embodiments, in Formula 1, a, x, y and z may satisfy 1.25≤a/(x+y+z)≤1.8, 1.47≤a/(x+y+z)≤1.8, 1.20≤a/(x+y+z)≤1.47, or 1.25≤a/(x+y+z)≤1.47. For example, a/(x+y+z) may represent the ratio of the number of moles of lithium included in the lithium metal oxide particle to the total number of moles of transition metals included in the lithium metal oxide particle.

Within the above a/(x+y+z) range, a sufficient amount of lithium exists in the transition metal layer, such that an excessive decrease in the number of moles of the transition metal may be suppressed while the capacity characteristics are improved.

The chemical structure represented by Formula 1 indicates a bonding relationship between elements included in the layered structure or crystal structure of the lithium metal oxide particles, and does not exclude other additional elements. For example, M, Ni and Mn in Formula 1 may be provided as main active elements of the cathode active material. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance the chemical stability of the lithium metal oxide particles or the layered structure/crystal structure. The auxiliary element may be incorporated into the layered structure/crystal structure together to form a bond, and it should be understood that this case is also included within the chemical structure range represented by Formula 1.

The auxiliary element may include, for example, at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element which contributes to the capacity/output activity of the cathode active material together with Co or Mn like Al.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium metal oxide particles, or may penetrate through the surface of the lithium-nickel metal composite oxide particles to become incorporated into the bonding structure represented by Formula 1 above.

The cathode active material may include a nickel-cobalt-manganese (NCM)-based lithium oxide. In this case, an NCM-based lithium oxide with an increased content of nickel may be used.

Ni may be provided as a transition metal associated with the output and capacity of the lithium secondary battery. Therefore, as described above, by employing a high-content (High-Ni) composition in the cathode active material, a high-capacity cathode and a high-capacity lithium secondary battery may be provided.

In this regard, as the content of Ni increases, long-term storage stability and cycle life stability of the cathode or the secondary battery may be relatively reduced, and side reactions with the electrolyte may also increase. However, according to exemplary embodiments, by including Co, the cycle life stability and capacity retention characteristics may be improved through Mn while maintaining electrical conductivity.

The content of Ni (e.g., a molar fraction of nickel based on a total number of moles of nickel, cobalt and manganese) in the NCM-based lithium oxide may be 0.21 or more, 0.34 or more, 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

According to exemplary embodiments, the lithium secondary battery includes a non-aqueous electrolyte. For example, the non-aqueous electrolyte includes a non-aqueous organic solvent and a lithium salt.

For example, the cathode active material including the above-described lithium metal oxide particles may be driven at a high voltage of 4.5 V or more. For example, the lithium metal oxide particles having a composition of Formula 1 may be activated under a high voltage environment of 4.5 V or more.

In the comparative example, when the lithium secondary battery is driven in the high voltage environment, the non-aqueous electrolyte may be decomposed, resulting in an increase in gas generation amount. Accordingly, the cycle life characteristics and driving stability of the lithium secondary battery may be degraded.

According to exemplary embodiments, a content of the cyclic carbonate compound included in the non-aqueous electrolyte may be less than 2 wt %. Within the above range, the content of the cyclic carbonate compound, which is easily decomposed in the high voltage environment, may be reduced, thereby improving the cycle life characteristics during high voltage charge and discharge.

In one embodiment, the non-aqueous electrolyte may not include a cyclic carbonate compound. Accordingly, gas generation due to decomposition of the non-aqueous electrolyte may be further suppressed.

The cyclic carbonate compound may include at least one selected from the group consisting of, for example, ethylene carbonate (EC), propylene carbonate (PC), gamma-butyrolactone (GBL), and fluoroethylene carbonate (FEC).

In some embodiments, the non-aqueous organic solvent may include a linear carbonate compound and a propionate compound.

The linear carbonate compound may include, for example, at least one selected from the group consisting of dimethyl carbonate (DMC), diethyl carbonate (DEC), dipropyl carbonate (DPC), ethyl methyl carbonate (EMC), methyl propyl carbonate (MPC) and ethyl propyl carbonate (EPC).

For example, the oxidation resistance of the non-aqueous electrolyte may be improved by using the propionate compound, thereby further enhancing the operating stability of the lithium secondary battery.

The propionate compound may include, for example, at least one selected from the group consisting of methyl propionate (MP), ethyl propionate (EP) and propyl propionate (PP).

According to some embodiments, a content of the propionate compound may be 4% by volume (“vol %”) or more, or 65 vol % or more based on the total volume of the non-aqueous organic solvent. According to some embodiments, a content of the propionate compound may be 5 vol % to 60 vol %, 5 vol % or more, 10 vol % or more, 20 vol % or more, 30 vol % or more, 50 vol % or more, or 5 vol % to 15 vol % based on the total volume of the non-aqueous organic solvent. Within the above range, the oxidation resistance of the non-aqueous electrolyte may be improved while also enhancing the ionic conductivity.

In exemplary embodiments, the lithium salt may be provided as the electrolyte. For example, the lithium salt may be represented by Li X″.

For example, as an anion (X) of the lithium salt,
F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂ (CF₃)₂CO⁻, (CF₃SO₂)₂CH⁻, (SF₅)₃C⁻, (CF₃SO₂)₃C⁻, CF₃ (CF₂)₇SO₃⁻, CF₃CO₂⁻, CH₃CO₂⁻, SCN⁻ and (CF₃CF₂SO₂)₂N⁻, etc. may be exemplified.

In some embodiments, the lithium salt may include at least one selected from the group consisting of lithium tetrafluoroborate (LiBF₄), lithium hexafluorophosphate (LiPF₆) and lithium difluorophosphate (LiPO₂F₂). In this case, a film with excellent thermal stability may be formed on the electrode surface. Accordingly, the ionic conductivity and electrode protection characteristics of the non-aqueous electrolyte may be improved.

In one embodiment, the lithium salt may be included in the non-aqueous organic solvent at a concentration of about 0.01 M to 5 M, or about 0.01 M to 2 M. Within the above range, the transfer of lithium ions and/or electrons may be promoted during charge and discharge operations of the lithium secondary battery, thereby improving the output characteristics.

Hereinafter, a lithium secondary battery including the cathode and the non-aqueous electrolyte will be described with reference to FIGS. 1 and 2.

Referring to FIGS. 1 and 2, the lithium secondary battery may include a cathode 100 including a cathode active material containing the above-described lithium metal oxide particles, and an anode 130 disposed to face the cathode 100.

The cathode 100 may include a cathode current collector 105, and a cathode active material layer 110 disposed on at least one surface of the cathode current collector 105 and including a cathode active material containing the above-described lithium metal oxide particles.

The cathode current collector 105 may include stainless steel, nickel, aluminum, titanium, or an alloy thereof. The cathode current collector 105 may also include aluminum or stainless steel subjected to surface treatment with carbon, nickel, titanium or silver. For example, the cathode current collector 105 may have a thickness of 10 to 50 μm.

The cathode active material may be mixed in a solvent to prepare a cathode slurry. The cathode slurry may be applied to at least one surface of the cathode current collector 105, followed by drying and pressing the same, to prepare the cathode active material layer 110. The coating may include a method such as gravure coating, slot die coating, simultaneous multilayer die coating, imprinting, doctor blade coating, dip coating, bar coating or casting. The cathode active material layer 110 may further include a binder, and optionally further include a conductive material, a thickener or the like.

As the solvent, N-methyl-2-pyrrolidone (NMP), dimethylformamide, dimethylacetamide, N,N-dimethylaminopropylamine, ethylene oxide, tetrahydrofuran, and the like may be used.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. These may be used alone or in combination of two or more thereof.

In one embodiment, a PVDF-based binder may be used as the cathode binder. In this case, the amount of binder for forming the cathode active material layer 110 may decrease and the amount of the cathode active material may relatively increase. Accordingly, the output characteristics and capacity characteristics of the secondary battery may be improved.

The conductive material may be added to the cathode active material layer 110 in order to enhance the conductivity thereof and/or the mobility of lithium ions or electrons. For example, the conductive material may include a carbon-based conductive material such as graphite, carbon black, acetylene black, Ketjen black, graphene, carbon nanotubes, vapor-grown carbon fibers (VGCFs), carbon fibers, and/or a metal-based conductive material including tin, tin oxide, titanium oxide, or a perovskite material such as LaSrCoO₃, and LaSrMnO₃. These may be used alone or in combination of two or more thereof.

The cathode slurry may further include a thickener and/or dispersant. In one embodiment, the cathode slurry may include a thickener such as carboxymethyl cellulose (CMC).

The anode 130 may include an anode current collector 125, and an anode active material layer 120 formed on at least one surface of the anode current collector 125.

For example, the anode current collector 125 may include a copper foil, a nickel foil, a stainless steel foil, a titanium foil, a nickel foam, a copper foam, a polymer substrate coated with conductive metal and the like. These may be used alone or in combination of two or more. For example, the anode current collector 125 may have a thickness of 10 μm to 50 μm.

The anode active material layer 120 may include an anode active material. A material capable of intercalating and deintercalating lithium ions may be used as the anode active material. For example, the anode active material may include carbon-based materials such as crystalline carbon, amorphous carbon, a carbon composite, or carbon fibers, etc.; lithium metal; a lithium alloy; a silicon (Si)-containing material or a tin (Sn)-containing material, etc. These may be used alone or in combination of two or more thereof.

The amorphous carbon may include hard carbon, soft carbon, cokes, mesocarbon microbead (MCMB), mesophase pitch-based carbon fiber (MPCF) or the like.

The crystalline carbon may include graphite-based carbon such as natural graphite, artificial graphite, graphite cokes, graphite MCMB, graphite MPCF or the like.

The lithium metal may include pure lithium metal and/or lithium metal having a protective layer formed thereon for suppressing dendrite growth and the like. In one embodiment, a lithium metal-containing layer deposited or applied to the anode current collector 125 may also be used as the anode active material layer 120. In one embodiment, a lithium thin film layer may also be used as the anode active material layer 120.

Elements contained in the lithium alloy may include aluminum, zinc, bismuth, cadmium, antimony, silicon, lead, tin, gallium, indium, etc. These may be used alone or in combination of two or more thereof.

The silicon-containing material may provide further increased capacity characteristics. The silicon-containing material may include Si, SiOₓ (0<x<2), metal-doped SiOₓ (0<x<2), a silicon-carbon composite, etc.

The metal may include lithium and/or magnesium, and the metal-doped SiOₓ (0<x<2) may include a metal silicate.

The anode active material may be mixed in a solvent to prepare an anode slurry. The anode slurry may be applied/deposited to the anode current collector 125, followed by drying and pressing the same, to prepare the anode active material layer 120. The coating may include a method such as gravure coating, slot die coating, simultaneous multilayer die coating, imprinting, doctor blade coating, dip coating, bar coating or casting, etc. The anode active material layer 120 may further include a binder, and optionally further include a conductive material, a thickener or the like.

The solvent included in the anode slurry may include water, pure water, deionized water, distilled water, ethanol, isopropanol, methanol, acetone, n-propanol, t-butanol and the like. These may be used alone or in combination of two or more thereof.

The above-described materials that can be used when preparing the cathode 100 as the binder, conductive material and thickener may be used for the anode.

In some embodiments, a styrene-butadiene rubber (SBR)-based binder, carboxymethyl cellulose (CMC), polyacrylic acid-based binder, poly(3,4-ethylenedioxythiophene, PEDOT)-based binder, and the like may be used as an anode binder. These may be used alone or in combination of two or more thereof.

In exemplary embodiments, a separation membrane 140 may be interposed between the cathode 100 and the anode 130. The separation membrane 140 may be configured to prevent an electrical short-circuit between the cathode 100 and the anode 130, and to allow a flow of ions to occur. For example, the separation membrane may have a thickness of 10 μm to 20 μm.

For example, the separation membrane 140 may include a porous polymer film or a porous nonwoven fabric.

The porous polymer film may include a polyolefin-based polymer such as an ethylene polymer, a propylene polymer, an ethylene/butene copolymer, an ethylene/hexene copolymer, and an ethylene/methacrylate copolymer, etc. These may be used alone or in combination of two or more thereof.

The porous nonwoven fabric may include glass fibers having a high melting point, polyethylene terephthalate fibers, etc.

The separation membrane 140 may also include a ceramic-based material. For example, inorganic particles may be applied to the polymer film or dispersed within the polymer film to improve heat resistance.

The separation membrane 140 may have a single-layer or multi-layer structure including the above-described polymer film and/or non-woven fabric.

According to exemplary embodiments, an electrode cell is defined by the cathode 100, the anode 130 and the separation membrane 140, and a plurality of electrode cells are stacked to form, for example, a jelly roll type electrode assembly 150. For example, the electrode assembly 150 may be formed by winding, stacking, z-folding, stack-folding, etc. the separation membrane 140.

The electrode assembly 150 may be housed in a case 160 together with the non-aqueous electrolyte to define a lithium secondary battery.

Hereinafter, embodiments of the present disclosure will be further described with reference to specific experimental examples. However, the following examples and comparative examples included in the experimental examples are only given for illustrating the present disclosure and those skilled in the art will obviously understand that various alterations and modifications are possible within the scope and spirit of the present disclosure. Such alterations and modifications are duly included in the appended claims.

### Example 1

### (1) Preparation of Cathode Active Material

Distilled water from which dissolved oxygen had been removed was input into a sealed reactor, and NiSO₄·6H₂O and MnSO₄·H₂O were further added thereto in a molar ratio of 38.1:61.9.

NaOH as a precipitant and NH₄OH as a chelating agent were further added to the reactor, and a co-precipitation reaction was performed for 60 hours, thus to prepare metal hydroxide particles.

The metal hydroxide particles were dried at 100 °C for 12 hours.

The dried metal hydroxide particles and lithium hydroxide were input into a dry mixer to prepare a mixture.

A mixing ratio of the metal hydroxide particles and lithium hydroxide was adjusted so that the resulting composition of the lithium metal oxide particles, as determined by the inductively coupled plasma (ICP) analysis, was Li_{1.11}Ni_{0.34}Mn_{0.55}O₂. The ICP analysis was performed using a 5800 ICP-OES device from Agilent.

The mixture was placed in a calcination furnace, and the temperature of the calcination furnace was increased to 250 °C at a rate of 2 °C/min, then a first calcination was performed while maintaining the temperature at 250 °C for 3 hours.

After the first calcination, the temperature of the calcination furnace was increased to 850 °C at a rate of 2 °C/min, and a second calcination was performed while maintaining the temperature at 850 °C for 8 hours.

Oxygen gas was continuously supplied to the calcination furnace at a flow rate of 10 mL/min during the first and second calcinations.

After complementation of the calcination, the calcined product was naturally cooled to room temperature, then pulverized and classified to prepare lithium metal oxide particles.

As a result of performing ICP analysis after normalizing the number of oxygen atoms to 2 for the lithium metal oxide particles, the composition was confirmed to be Li_{1.11}Ni_{0.34}Mn_{0.55}O₂.

The prepared lithium metal oxide particles were used as the cathode active material.

### (2) Preparation of Non-Aqueous Electrolyte

A non-aqueous electrolyte was prepared by dissolving LiPF₆ in a mixed solvent of EMC/EP (in a volume ratio of 90:10) at a concentration of 1.0 M.

### (3) Manufacture of Lithium Secondary Battery

A lithium secondary battery was manufactured using the prepared cathode active material and non-aqueous electrolyte.

Specifically, the prepared cathode active material, Denka Black as a conductive material, and PVDF as a binder were mixed in a mass ratio of 93:5:2 to prepare a cathode slurry. The cathode slurry was applied to an aluminum current collector (thickness: 15 μm), followed by vacuum drying at 130 °C and pressing the same, to prepare a cathode.

Lithium (Li) metal having a thickness of 15 μm was used as the anode.

The cathode and anode prepared as described above were each notched into circular shapes having diameters of Φ14 and Φ16, respectively, and laminated with a separation membrane (polyethylene, thickness: 13 μm) notched into Φ19 interposed between the cathode and the anode to form an electrode cell. The electrode cell was placed in a coin cell outer case having a diameter of 20 mm and a height of 1.6 mm, followed by electrolyte injection and assembly. Thereafter, aging was carried out for 12 hours or more to allow the electrolyte to be impregnated into the electrode.

Formation charging and discharging were performed on the secondary battery manufactured as described above (charging conditions: CC-CV 1 C 4.6 V 0.05 C CUT-OFF, discharge conditions: CC 1 C 2.0 V CUT-OFF).

### Examples 2 to 9

Cathode active materials, non-aqueous electrolytes, and lithium secondary batteries were manufactured in the same manner as in Example 1, except that the composition of the non-aqueous organic solvent was adjusted as shown in Table 1 below.

### Example 10

A cathode active material, a non-aqueous electrolyte, and a lithium secondary battery were manufactured in the same manner as in Example 1, except that the input amounts of LiOH. H₂O, NiSO₄·6H₂O, CoSO₄·7H₂O and MnSO₄·H₂O were adjusted so that the composition of the lithium metal oxide particles was Li_{1.19}Ni_{0.21}Co_{0.02}Mn_{0.58}O₂.

### Comparative Examples 1 to 3

Cathode active materials, non-aqueous electrolytes, and lithium secondary batteries were manufactured in the same manner as in Example 1, except that the composition of the non-aqueous organic solvent, and the content of EC based on the total weight of the non-aqueous electrolyte were adjusted as shown in Table 1 below.

### Comparative Example 4

A cathode active material, a non-aqueous electrolyte, and a lithium secondary battery were manufactured in the same manner as in Example 1, except that the input amounts of LiOH·H₂O, NiSO₄·6H₂O, and MnSO₄·H₂O were adjusted so that the composition of the lithium metal oxide particles was Li_{1.02}Ni_{0.38}Mn_{0.60}O₂.

The composition (formula) of the cathode active material, the ratio (Li/Me) of the number of moles of lithium contained in the lithium metal oxide particles to the total number of moles of metals excluding lithium contained in the lithium metal oxide particles, the composition (volume ratio) of the non-aqueous electrolyte solvent, and the content of the cyclic carbonate compound are shown in Table 1 below.

TABLE 1

| | | | Non-aqueous electrolyte | | |
|---|---|---|---|---|---|
| | | | | | Content of |
| | | | Non-aqueous | | cyclic |
| | | | organic solvent | | carbonate |
| | Cathode active material | | composition | | compounds |
| Item | Composition (formula) | Li/Me | (volume ratio) | | (wt %) |
| Example 1 | Li_{1.11}Ni_{0.34}Mn_{0.55}O₂ | 1.25 | EMC:EP | (90:10) | 0 |
| Example 2 | Li_{1.11}Ni_{0.34}Mn_{0.55}O₂ | 1.25 | DEC:EP | (90:10) | 0 |
| Example 3 | Li_{1.11}Ni_{0.34}Mn_{0.55}O₂ | 1.25 | EMC:PP | (90:10) | 0 |
| Example 4 | Li_{1.11}Ni_{0.34}Mn_{0.55}O₂ | 1.25 | EMC:EP | (96:4) | 0 |
| Example 5 | Li_{1.11}Ni_{0.34}Mn_{0.55}O₂ | 1.25 | EMC:EP | (35:65) | 0 |
| Example 6 | Li_{1.11}Ni_{0.34}Mn_{0.55}O₂ | 1.25 | EMC:EP | (80:20) | 0 |
| Example 7 | Li_{1.11}Ni_{0.34}Mn_{0.55}O₂ | 1.25 | EMC:EP | (70:30) | 0 |
| Example 8 | Li_{1.11}Ni_{0.34}Mn_{0.55}O₂ | 1.25 | EMC:EP | (50:50) | 0 |
| Example 9 | Li_{1.11}Ni_{0.34}Mn_{0.55}O₂ | 1.25 | EMC:EP | (40:60) | 0 |
| Example 10 | Li_{1.19}Ni_{0.21}Co_{0.02}Mn_{0.58}0₂ | 1.47 | EMC:EP | (90:10) | 0 |
| Comparative | Li_{1.11}Ni_{0.34}Mn_{0.55}O₂ | 1.25 | EC:EMC:DEC | (25:45:30) | 26.64 |
| Example 1 | | | | | |
| Comparative | Li_{1.11}Ni_{0.34}Mn_{0.55}O₂ | 1.25 | FEC:EMC | (10:90) | 12.25 |
| Example 2 | | | | | |
| Comparative | Li_{1.11}Ni_{0.34}Mn_{0.55}O₂ | 1.25 | FEC:DMC | (50:50) | 51.84 |
| Example 3 | | | | | |
| Comparative | Li_{1.02}Ni_{0.38}Mn_{0.60}O₂ | 1.04 | EMC:EP | (90:10) | 0 |
| Example 4 | | | | | |

### Experimental Example

### (1) Measurement of Gas Generation Amount at 45 °C.

The lithium secondary batteries manufactured according to the above-described examples and comparative examples were charged (CC-CV 1 C 4.6V 0.05 C CUT-OFF) and then stored in a chamber at 45 °C for 8 weeks. Thereafter, the lithium secondary batteries were left at room temperature for 30 minutes, and placed in a chamber for measuring the gas generation amount.

After creating a vacuum in the chamber, nitrogen gas was filled to form an atmospheric pressure, and the nitrogen volume (V₀) at the atmospheric pressure and the internal pressure (P₀) of the chamber were measured.

After creating a vacuum again inside the chamber, a hole was made in the lithium secondary battery and it was left for 1 hour. Subsequently, the internal pressure (P₁) of the chamber was measured and then the gas generation amount was measured by substituting the value into the following equation.

Gas generation amount (mL)=(V₀/P₀)×P₁

### (2) Evaluation of Capacity Retention Rate at 45 °C

The lithium secondary batteries manufactured according to the above-described examples and comparative examples were charged (CC/CV 1 C 4.6 V 0.05 C CUT-OFF) and discharged (CC 1 C 2.0 V CUT-OFF) 100 times in a chamber at 45 °C.

The capacity retention rate was calculated as the percentage obtained by dividing the discharge capacity at the 100th cycle by the discharge capacity at the 1st cycle.

Capacity retention rate (%)=(Discharge capacity at 100th cycle/Discharge capacity at 1st cycle)×100

### (3) Measurement of Initial Discharge Capacity

Charging (CC/CV 0.1 C 4.6V 0.05 C CUT-OFF) and discharging (CC 0.1 C 2.0V CUT-OFF) were each performed once on the lithium secondary batteries manufactured according to the above-described examples and comparative examples, and the initial discharge capacity was measured.

The initial discharge capacity is defined as a value obtained by dividing the absolute capacity (mAh) of the lithium secondary battery by the total weight (g) of the cathode active material in the battery.

The evaluation results are shown in Table 2 below.

TABLE 2

| | Gas generation | Capacity retention | |
|---|---|---|---|
| | amount (45 °C) | rate (45 °C) | Initial discharge |
| Item | (mL) | (%, 100th cycle) | capacity (mAh/g) |
| Example 1 | 8.6 | 93.5 | 210 |
| Example 2 | 8.3 | 93.3 | 210 |
| Example 3 | 8.9 | 93.7 | 210 |
| Example 4 | 13.7 | 92.5 | 210 |
| Example 5 | 15.2 | 91.3 | 210 |
| Example 6 | 9.1 | 92.9 | 210 |
| Example 7 | 9.4 | 92.6 | 210 |
| Example 8 | 10.2 | 92.5 | 210 |
| Example 9 | 11.3 | 91.9 | 210 |
| Example 10 | 9.0 | 92.8 | 247 |
| Comparative | 76.9 | 73.9 | 210 |
| Example 1 | | | |
| Comparative | 55.3 | 80.1 | 210 |
| Example 2 | | | |
| Comparative | 164.2 | 61.5 | 210 |
| Example 3 | | | |
| Comparative | 8.5 | 92.1 | 140 |
| Example 4 | | | |

Referring to Table 1 and Table 2, in the examples, where the cyclic carbonate compound was included in an amount less than 2 wt % based on the total weight of the non-aqueous electrolyte, the gas generation amount in a high voltage environment was reduced, and the capacity retention rate was improved compared to the comparative examples.

In addition, in the examples using the cathode active material containing excess lithium, the capacity characteristics were improved compared to the comparative examples.

In Example 4, where the content of the propionate compound was less than 5 vol % based on the total volume of the non-aqueous organic solvent, the oxidation resistance was relatively reduced, and the cycle life capacity retention rate was reduced.

In Example 5, where the content of the propionate compound was greater than 60 vol % based on the total volume of the non-aqueous organic solvent, side reactions with the electrolyte were relatively increased.

In Comparative Example 4, where the ratio of the number of moles of lithium contained in the lithium metal oxide particles to the total number of moles of metal excluding lithium contained in the lithium metal oxide particles was less than 1.05, the amount of lithium present in the transition metal layer of the layered structure was reduced, and the initial capacity was decreased compared to the examples.

1. A lithium secondary battery comprising:
a cathode which comprises a cathode active material including lithium metal oxide particles;
an anode disposed to face the cathode; and
a non-aqueous electrolyte comprising a non-aqueous organic solvent and a lithium salt,
wherein a ratio of the number of moles of lithium included in the lithium metal oxide particles to the total number of moles of metals excluding lithium included in the lithium metal oxide particles is 1.05 or more, and
a content of a cyclic carbonate compound included in the non-aqueous electrolyte is less than 2 wt % based on a total weight of the non-aqueous electrolyte.

2. The lithium secondary battery according to claim 1, wherein the cyclic carbonate compound comprises at least one selected from the group consisting of ethylene carbonate, propylene carbonate, gamma-butyrolactone and fluoroethylene carbonate.

3. The lithium secondary battery according to claim 1, wherein the non-aqueous electrolyte does not include the cyclic carbonate compound.

4. The lithium secondary battery according to claim 1, wherein the non-aqueous organic solvent comprises a linear carbonate compound and a propionate compound.

5. The lithium secondary battery according to claim 4, wherein a content of the propionate compound is 5% by volume to 60% by volume based on a total volume of the non-aqueous organic solvent.

6. The lithium secondary battery according to claim 5, wherein the content of the propionate compound is 5% by volume to 15% by volume based on the total volume of the non-aqueous organic solvent.

7. The lithium secondary battery according to claim 4, wherein the propionate compound comprises at least one selected from the group consisting of methyl propionate, ethyl propionate and propyl propionate.

8. The lithium secondary battery according to claim 4, wherein the linear carbonate compound comprises at least one selected from the group consisting of dimethyl carbonate, diethyl carbonate, dipropyl carbonate, ethylmethyl carbonate, methylpropyl carbonate and ethylpropyl carbonate.

9. The lithium secondary battery according to claim 1, wherein the lithium salt comprises at least one selected from the group consisting of lithium tetrafluoroborate (LiBF₄), lithium hexafluorophosphate (LiPF₆) and lithium difluorophosphate (LiPO₂F₂).

10. The lithium secondary battery according to claim 1, wherein the lithium metal oxide particles are represented by Formula 1 below:
Liₐ[MₓNi_{y}Mn_{z}]O_{b} [Formula 1]
(in Formula 1, M is at least one of Co, Na, Ca, Y, Hf, Ta, Fe, B, Si, Ba, Ra, Mg, V, Ti, Al, Ru, Zr, W, Sn, Nb, Mo, Cu, Zn, Cr, Ga, V, and Bi, and x, y, z, a and by satisfy 0≤x≤0.9, 0≤y≤0.9, x+y>0, 0.1≤z≤0.9, 1.8≤a+x+y+z≤2.2, 1.05≤a/(x+y+z)≤1.95, and 1.8≤b≤2.2).

11. The lithium secondary battery according to claim 10, wherein a, x, y and z satisfy 1.2≤a/(x+y+z)≤1.8.
